(19) United States
(12) Patent Application Publication
(10) Pub. No.: US 2023/0236580 A1
(43) Pub. Date: Jul. 27, 2023

(54) METHOD FOR OPERATING AN ASSEMBLY

(71) Applicant: Julius Blum GmbH, Hoechst (AT)

(72) Inventors: Thomas RUEDISSER, Hohenems (AT); Florian BURTSCHER, Dornbirn (AT); Thomas TAIMLER, Hoechst (AT)

(21) Appl. No.: 18/070,992

(22) Filed: Nov. 29, 2022

Related U.S. Application Data
(63) Continuation of application No. PCT/AT2021/060192, filed on Jun. 2, 2021.

(30) Foreign Application Priority Data
Jun. 5, 2020 (AT) A 50489/2020

(51) Int. Cl. G05B 19/418; A47C 31/00

(52) U.S. Cl. CPC G05B 19/41805; A47C 31/008

(57) ABSTRACT

A method for operating an assembly includes providing a furniture part which can be arranged by a furniture drive in at least two operating positions relative to a furniture body. In chronological order, a command transmitter spatially separated from the furniture drive transmits at least one digital command to a data transmission device of the furniture drive via the data transmission device of the command transmitter. A computing unit of the furniture drive compares the at least one digital command with at least one digital data set stored in a storage unit, and the computing unit makes a selection on the basis of the result of the comparison to carry out the at least one digital command.

The invention concerns a method for operating an assembly comprising at least one furniture drive with at least one storage unit and at least one computing unit, at least one furniture part movably mounted on a furniture body, wherein the at least one furniture part can be arranged by the at least one furniture drive in at least two operating positions relative to the furniture body, and at least one command transmitter spatially separate from the at least one furniture drive, wherein the at least one furniture drive and the at least one command transmitter each comprise at least one data forwarding device. Furthermore, the invention concerns a computer program product for carrying out such a method. Furthermore, the invention concerns an assembly comprising at least one furniture drive with at least one storage unit and at least one computing unit, at least one furniture part movably mounted on a furniture body, wherein the at least one furniture part can be arranged by the at least one furniture drive in at least two operating positions relative to the furniture body, and at least one command transmitter spatially separate from the at least one furniture drive, wherein the at least one furniture drive and the at least one command transmitter each comprise at least one data forwarding device. The invention further concerns a furniture drive for such an assembly, comprising at least one fixing device for fixing the furniture drive to a furniture body, at least one positioning device with which at least one moveable furniture part is moveable relative to the furniture body, at least one drive unit with which the at least one positioning device can be driven, in particular electrically, at least one storage unit, at least one computing unit, and at least one data forwarding device.

In the prior art it is known—for instance from WO 2008/141348 A2—that command transmitters communicate with a furniture drive in order to move a moveable furniture part. For this purpose, a user actuates a switching element which acts as a command transmitter, wherein a drive device of the furniture drive is triggered by cable, and the drive device moves the moveable furniture part between two operating positions.

A disadvantage of the prior art is that the furniture drive does not comprise any information about other furniture drives, wherein this causes the risk of colliding furniture parts, since for instance a simultaneous or successive triggering of furniture drives in an assembly of at least two furniture drives for at least two moveable furniture parts can evoke a collision of the moveable furniture parts. Furthermore, a synchronization of furniture drives is not possible, wherein for instance in case of two furniture drives, which are both arranged at a moveable furniture part or which have to move two moveable furniture parts in a specific order, a proper motion of the furniture parts cannot be guaranteed.

The objective technical object of the present invention is therefore to disclose a method for operating such an assembly, which is improved with respect to the prior art, as well as a computer program product, such an assembly and a furniture drive for such an assembly, in which the disadvantages of the prior art are at least partially eliminated, and which are characterized in particular by a reduced susceptibility to errors.

This object is accomplished by the characteristics of claim 1.

It is therefore provided according to the invention that the following method steps are carried out, in particular in chronological order:
the at least one command transmitter transmits, in particular wireless signal-transmitting, at least one digital command to the at least one data forwarding device of the at least one furniture drive via the at least one data forwarding device of the at least one command transmitter,
the at least one computing unit of the at least one furniture drive compares the at least one digital command with at least one digital data set stored or storable in the at least one storage unit, and
the at least one computing unit makes a selection for carrying out the at least one digital command depending on a result of the comparison.

This only makes it possible for the at least one furniture drive to have its own independent intelligence, separate from the command transmitter, via which the at least one furniture drive can check the at least one digital command of the at least one command transmitter with regard to feasibility. If the at least one digital command cannot be carried out, for instance due to an impending collision, without risking damage to the at least one moveable furniture part, the at least one furniture drive can prevent the at least one digital command from being carried out.

Furthermore, it is made possible that the command transmitter only has to communicate with one furniture drive in order to realize a synchronized motion of at least two furniture drives, since the at least one furniture drive can have stored information regarding additional furniture drives in the at least one digital data set, which do not have to be known to the at least one command transmitter. Following an input of the at least one digital command, the at least one furniture drive can communicate with additional furniture drives and instruct them to move synchronously in the sense of a sequential or simultaneous motion of the at least one moveable furniture part.

There is furthermore the positive effect that the at least one command transmitter does not have to store any information regarding additional furniture drives to the digital command, since these can already be stored in the at least one digital data set, so that the data communication between the at least one command transmitter and the at least one furniture drive can take place more efficiently, since a reduced amount of data has to be transmitted, and this can take place more quickly, as well as the at least one command transmitter requires a reduced computing power and can use these gained resources for other digital commands.

In addition, a configuration of the assembly is facilitated, since the at least one command transmitter does not need to know the entire information of a network in which the at least one furniture drive is located, and the at least one furniture drive only needs to know such information which is indispensable for a proper motion of the respective moveable furniture parts.

Furthermore, the resilience of the assembly is increased because, although the at least one command transmitter can have higher-level intelligence, the at least one furniture drive has required information for proper operation through the at least one digital data set. The at least one furniture drive can obtain information of additional furniture drives by a connection to additional furniture drives or to the at least one command transmitter, which enables an exchange of the at least one digital data set or information about the network. This increases the resilience of the assembly, since the at least one additional furniture drive knows information of the at least one digital data set of the at east one furniture drive and/or can prevent a collision or enable synchronization in case of a failure.

The at least one digital data set can be stored in the at least one computing unit during an assembly of the at least one furniture drive, for instance via an electronic device or an HMI (human-machine interface) of the at least one furniture drive, and/or can be supplemented by the at least one electronic device or the HMI of the at least one furniture drive after an assembly.

In addition, incorrect commands are reduced by the at least one command transmitter by comparing the digital command with the digital data set.

If the at least one command transmitter trans s the at least one digital command in a wireless signal-transmitting manner, the at least one command transmitter can be located spatially separate from the at least one furniture drive without a cable connection to be taken from the prior art.

The at least one data forwarding device can comprise a receiving device and a spatially separate transmitting device or have the receiving device and the transmitting device integrated.

The at least one furniture drive can, in particular, instruct additional furniture drives for a proper motion of furniture parts by means of additional digital commands after a selection has been made, wherein a synchronization between the furniture drive and the additional furniture drives is particularly preferable, but does not necessarily have to take place.

As stated at the beginning, protection is also requested for a computer program product comprising commands which, when carried out by a computing unit, cause the computing unit to carry out a method according to at least one of the preceding claims from a storage unit which is or can be brought into a data connection with the computing unit.

As stated at the beginning, protection is also requested for an assembly according to the preamble of claim 21, wherein the at least one command transmitter is designed in such a way that at least one digital command is transmitted to the at least one data forwarding device of the at least one furniture drive via the at least one data forwarding device of the at least one command transmitter, in particular in a wireless signal-transmitting manner, the at least one computing unit of the at least one furniture drive is designed in such a way as to compare the at least one digital command with at least one digital data set stored in the at least one storage unit, and the at least one computing unit is designed in such a way as to make a selection for carrying out the at least one digital command depending on a result of the comparison.

As stated at the beginning, protection is also requested for a furniture drive according to the preamble of claim 24, wherein such a computer program product is stored on the furniture drive, which can be carried out by the at least one computing unit.

The computer program product can, for instance, be stored in the at least one storage unit and be carried out by the at least one computing unit.

Advantageous embodiments of the invention are defined in the dependent claims.

Advantageously, it is provided that the at least one digital command in the form of a closing command or an opening command, in which the at least one furniture part can be arranged by the at least one furniture drive from an operating position relative to the furniture body into an operating position different therefrom, and/or a locking command or an unlocking command, in which the at least one furniture part remains in an operating position.

In general, the locking command can lock the at least one furniture drive in order to inhibit opening and/or closing of the at least one moveable furniture part. In general, the at least one furniture drive can also be designed as a furniture lock, wherein the locking command moves a locking device of the furniture lock into a locking position in which a motion of the at least one moveable furniture part is not possible. An analogous consideration is to be applied to the unlocking command with respect to an unlocked position. The digital command can in general also comprise additional control signals and/or operating commands.

It has proved advantageous that the selection is transferred to a Boolean variable, wherein the Boolean variable has the value 0 or 1 in case of feasibility of the at least one digital command, and the value 1 or 0 in case of non-feasibility of the at least one digital command.

This allows a data communication to be particularly efficient, since the at least one furniture drive can encode the selection by the Boolean variable via merely one bit of information and/or transmit it to the at least one command transmitter.

It has proved to be advantageous that in case of a selection for the feasibility of the at least one digital command, the at least one data forwarding device of the at least one furniture drive communicates, preferably via ESB, with at least one data forwarding device of at least one additional furniture drive, wherein it is preferably provided that the at least one furniture drive and the at least one additional furniture drive jointly arrange the at least one furniture part, preferably in parallel or sequentially, from an operating position into a further operating position, separate from the operating position, relative to the furniture body and/or lock the at least one furniture part in an operating position.

This way, based on a digital command to exactly one furniture drive, a motion of at least one moveable furniture part can be performed by a plurality of furniture drives, wherein a proper motion is ensured taking into account synchronization parameters, collision parameters and/or state parameters of the at least one digital data set of at least one furniture drive. In addition, a comparison of the digital data sets of the furniture drives can be carried out and/or the digital data set of the at least one additional furniture drive can be transmitted to the at least one command transmitter by the at least one furniture drive.

An advantageous variant is that the at least one digital data set comprises static parameters, preferably in the form of a reference parameter, synchronization parameter, coupling parameter, state parameter and/or collision parameter, relating to at least one possibly present additional furniture drive, particularly preferable a network in which the at least one furniture drive is located, wherein it is preferably provided that the state parameter can be changed depending on at least one operating position.

Reference parameters are for instance defined end positions of at least one positioning device, which define operating positions of the at least one furniture drive. Synchronization parameters are, for instance, time-defined sequences of an activation of at least one drive unit in order to coordinate a plurality of furniture drives for moving the at least one furniture part. Coupling parameters are for instance to be understood as a linkage of a furniture drive with a command transmitter, household appliance, radio switch element, additional furniture drive and/or the like in order to define a connection between two entities of a network. State parameter means, for instance, a locking and/or position of the at least one positioning device which images an opened or closed moveable furniture part, wherein the state parameter is changeable at a transition between operating positions of the at least one moveable furniture part.

It is particularly preferable that in a subsequent method step the at least one furniture drive, in particular wireless signal-transmitting, transmits at least one piece of digital information depending on the selection via the at least one data forwarding device of the at least one furniture drive to the at least one data forwarding device of the at least one command transmitter, wherein it is particularly preferable that
in case of feasibility of the at least one digital command, the at least one piece of digital information contains a confirmation of the feasibility,
in case of non-feasibility of the at least one digital command, the at least one piece of digital information comprises a confirmation of non-feasibility, wherein the at least one piece of digital information preferably comprises a reason for non-feasibility, particularly preferable in the form of a diagnosis with respect to the selection.

The at least one piece of digital information can confirm to the at least one command transmitter that the digital command is feasible. In case of non-feasibility, the at least one command transmitter can initiate an error analysis for non-feasibility, in particular on the basis of the diagnosis, and/or retransmit the at least one digital command, in particular after resolving the cause of non-feasibility.

It is also conceivable that the at least one command transmitter learns by machine learning and/or artificial intelligence through the at least one piece of digital information.

In one embodiment of the invention, it is provided that the at least one data forwarding device of the at least one furniture drive and the at least one command transmitter communicate bidirectionally in parallel or bidirectionally sequentially.

In general, data communication can be understood as data transmission by means of sending and receiving, wherein preferably, merely sending or receiving is carried out, at least temporarily. However, unidirectional data communication is also conceivable, wherein merely control commands are transmitted. Particularly preferable is data communication via radio signal protocols, wherein in general line-bound data communication is also possible. A receiving unit and a sending unit can for instance be present integrated on a chip or spatially separate from each other.

According to a preferred embodiment of the invention, it is provided that the at least one data forwarding device of the at least one furniture drive transmits at least one piece of digital information to the at least one data forwarding device of the at least one command transmitter in the event of a change of state of the at least one furniture drive, wherein a status message regarding the change of state is preferably displayed to an electronic device, particularly preferable in the form of a mobile terminal, smartphone or computer.

This way, after a change of state—such as locking of the at least one furniture drive or a changed operating position of the at least one moveable furniture part—based on at least one digital command, a user can be made aware that the at least one digital command has been carried out successfully. If the change of state is transmitted to the electronic device, a user has an overview of movements of the at least one moveable furniture part.

It has proven advantageous that the at least one command transmitter communicates with the at least one data forwarding device of the at least one furniture drive via BLE and/or ESB, and/or the at least one data forwarding device of the at least one furniture drive communicates with at least one possibly present additional furniture drive via ESB.

The technical term BLE as a radio protocol refers to Bluetooth Low Energy, which is integrated in commercially available electronic devices such as smartphones and computers.

The technical term ESB as a radio protocol refers to Enhanced Shockburst™, which has proven particularly advantageous for controlling furniture drives compared to BLE due to its lower latency times, among others.

In addition, it is preferably provided that the at least one digital command is transmitted to the at least one data forwarding device of the at least one furniture drive via at least one data transmission device spatially separate from the at least one command transmitter, wherein it is preferably provided that the at least one data transmission device communicates with the at least one data forwarding device of the at least one furniture drive via ESB.

If the at least one command transmitter does not have a radio protocol by which to communicate with the at least one furniture drive, the at least one data transmission device can forward the at least one digital command via a radio protocol by means of which the at least one furniture drive can receive digital data, wherein the data transmission device generates a translation between the two radio protocols.

The at least one command transmitter can communicate with the at least one data transmission device via ESB, WiFi and/or WAN, wherein a data communication between the data transmission device and the at least one furniture drive is particularly preferably provided via ESB. In particular, a reception can take place according to a transmission protocol according to IEEE 802.11 standard and/or bluetooth standard.

Alternatively, it is possible that the at least one command transmitter determines information, preferably at least one digital data set, of at least one additional furniture drive and/or of a network in which the at least one furniture drive is imaged, by means of a connection to the at least one data transmission device.

This enables the at least one command transmitter, when connected to merely one entity of the network, to obtain information of all entities located in the network without having to query each entity separately.

In general, each entity of the network—for instance the at least one furniture drive—can determine information of an additional furniture drive and/or of the network by a connection with the at least one data transmission device and/or at least one additional furniture drive.

In an additional preferable embodiment, it is provided that the at least one command transmitter determines information, preferably at least one digital data set, of at least one additional furniture drive and/or of a network in which the at least one furniture drive is imaged, by means of a connection with at least one, preferably exactly one, data forwarding device of the at least one furniture drive, and/or at least one, preferably exactly one, possibly present data transmission device.

This way, correlations of the network, in particular synchronization parameters and/or collision parameters of furniture drives, are known to the at least one command transmitter, and can for instance be used for fault diagnosis and/or suitable digital commands. In general, the at least one command transmitter can also represent a furniture drive which communicates with at least one additional furniture drive and/or household appliance.

According to an advantageous embodiment of the invention, it is provided that in a preceding method step, preferably via at least one electronic device, preferably in the form of a mobile terminal, smartphone or computer,
at least two furniture drives are coupled to one another and/or synchronized via a reference ride to be carried out by a user,
the at least one furniture drive is initialized via a reference ride to be carried out by a user,
the at least one furniture drive is coupled to the at least one command transmitter, and/or the at least one command transmitter is initialized via a reference ride to be carried out by a user,
at least one digital data set is stored in the at least one storage unit, depending on a reference ride to be carried out by a user, and/or
the at least one furniture drive, the at least one command transmitter and/or at least one possibly present data transmission device are added to a network, wherein it is preferably provided that the network is transmitted to the at least one command transmitter, and/or
at least one piece of digital information to an error message, particularly preferable with a help dialog, is optionally transmitted to the at least one command transmitter to at least one furniture drive and/or a possibly present data transmission device.

This way, the at least one digital data set can be filled with digital data relevant for a motion sequence of the at least one furniture part. The at least one digital data set can be used by the at least one furniture drive in such a way as to move the at least one moveable furniture part properly between operating positions, taking into account additional furniture drives, to instruct the additional furniture drives for proper motion, in particular by sending digital commands, and/or to make the digital data set available or accessible to the entities by means of a connection with entities of the network.

Once the selection has been made for not carrying out, this can be transmitted to the command transmitter with an error message in the form of the piece of digital information. For instance, the error message can comprise information about a problematic network structure, an incorrect adjustment of a drive unit, an insufficient installation depth, a continuous pressing of a moveable furniture part on a radio switch and/or a faulty firmware. in general, the piece of digital information can also be transmitted without prior selection for not being carried out.

According to an advantageous embodiment of the invention, it is provided that the at least one command transmitter comprises at least one computing unit and at least one storage unit, wherein it is preferably provided that at least one status parameter, at least one piece of log information and/or at least one operating information of the at least one furniture drive and/or of a possibly present data transmission device is read out from the at least one storage unit.

By means of an access of the at least one computing unit to the at least one storage unit, error commands due to insufficient digital commands can be reduced particularly effectively. In addition, a user can for instance determine an unwanted opening, a frequency of an opening of the at least one moveable furniture part or the like, and use them for instance for analysis purposes.

If a moveable furniture part is moved by an unauthorized person, or if a desired motion of a moveable furniture part has not yet taken place at a specific point in time, this information is accessible to a user.

Advantageously, it is provided that the at least one command transmitter is designed in the form of a radio switch element, a data transmission device, a furniture lock, a household appliance, an additional furniture drive and/or an electronic device, preferably in the form of a mobile terminal, smartphone or computer.

The at least one furniture drive can, for instance, receive a locking command or an opening command by actuating a radio switch element spatially separate from the furniture drive, a smartphone and/or a mobile terminal in the form of a voice recognition system, which is connected directly or via a data transmission device to the at least one data forwarding device of the at least one furniture drive in a wireless signal-transmitting manner.

Also a digital command of a household appliance in the form of a robot vacuum is possible, which requests an opening of the at least one moveable furniture part by the at least one furniture drive in order to be able to move in or out of a piece of furniture. In general, the household appliance can also be present, for instance, as a microwave or coffee machine, wherein while operating the household appliance, a closing of the at least one moveable furniture part is inhibited. In general, data communication between the robot vacuum and the at least one furniture drive is also conceivable via ultrasound.

Preventing a motion of the at least one moveable furniture part into a closed position as operating position can be inhibited, on the one hand, by transmitting a locking command via the at least one command transmitter, or, on the other hand, by a selection for non-executability of a dosing command by the at least one computing unit.

It has proved advantageous that the at least one command transmitter and/or the at least one possibly present data transmission device makes a preselection for carrying out the at least one digital command, preferably on the basis of information of the network in which the at least one furniture drive is located.

This way, a number of digital commands which lead to a non-executability of the digital commands due to synchronization parameters, collision parameters or other presettings can be reduced in a particularly favorable manner.

According to an advantageous embodiment of the invention, it is provided that a data communication between the at least one data forwarding device of the at least one command transmitter and the at least one data forwarding device of the at least one furniture drive is enabled in encrypted form and/or during defined time windows.

This provides particularly secure, rapid and/or robust data communication, wherein it is particularly preferable to provide an authentication and/or signing of data and/or an encryption of a data link.

It has proved advantageous that in a preceding method step at least one verbal voice command given by a user, preferably with user identification, and/or at least one tactile command is translated into the at least one digital command via at least one electronic device, particularly preferable in the form of a mobile terminal, smartphone or computer.

The voice command provides a particularly convenient control of the at least one furniture drive, since a user can, for instance, generate an opening or closing of specific moveable furniture parts by a suitable word or sequence of words. Through a user identification, a digital command of a specific person can for instance initiate a furniture drive not to move a moveable furniture part. The voice commands are moreover individually adaptable, wherein for instance the term “salt” can generate an opening of that moveable furniture part which has a salt shaker in its storage space, thereby enhancing a usability of the network. The number of entities located in the network is generally arbitrary. Without knowledge of an exact position of a desired content item, a user is given access to this item with the help of a simple verbal command, wherein an opening of the moveable furniture part is generated at least partially by the at least one furniture drive in order to be able to take out the desired content item. By means of a verbal command deviating therefrom, such as for instance “sugar”, a content item of a separate storage space can be made accessible.

By means of the tactile command, a user can, for instance, make a selection on a smartphone as to which moveable furniture part is to open when, or at which point in time the at least one moveable furniture part should not be openable.

An advantageous variant is that the at least one tactile command and/or the at least one verbal voice command is translated into the at least one digital command by the at least one command transmitter and/or in at least one cloud.

This way, a homogenization of the commands evoked by a user in the form of a digital command can be effected, which can be transmitted to the data forwarding device via a suitable radio protocol with low latency times.

It is particularly preferable that at least two furniture drives are arranged on the at least one moveable furniture part, wherein the at least one moveable furniture part is jointly moveable in parallel between the at least two operating positions relative to the furniture body by the at least two furniture drives.

This way, in particular heavily moveable furniture parts can be moved, wherein a synchronized motion of the furniture drives can be ensured by a data communication between the furniture drives. For this purpose, the at least one command transmitter merely has to send a digital command to merely one furniture drive, wherein an improper opening of the moveable furniture parts can be prevented by the intelligence of the furniture drive via selecting for carrying out.

In one embodiment of the invention, it is provided that on at least two moveable furniture parts at least one furniture drive is arranged in each case, wherein the at least two moveable furniture parts are moveable in parallel or sequentially by the at least two furniture drives between the at least two operating positions relative to the furniture body.

This way a plurality of storage spaces can be made accessible to a user, which are covered by a plurality of moveable furniture parts, wherein a collision of the moveable furniture parts is prevented by the selection for carrying out and/or a data communication between the furniture drives.

It has proved advantageous that at least one digital data set can be stored in the at least one storage unit, preferably via the at least one data forwarding device by at least one electronic device, wherein the at least one digital data set preferably comprises static parameters in the form of a reference parameter, synchronization parameter, coupling parameter, state parameter and/or collision parameter to at least one additional furniture drive.

This way, when assembling the furniture drive, for instance, the furniture drive can be configured in such a way that a joint or mandatory sequential motion of the at least one moveable furniture part takes place properly by a suitable time sequence of an actuation of the at least one positioning device of the furniture drives. In addition, the at least one digital data set is adjustable at any time, for instance when a change in the network or a change in the at least one moveable furniture part is effected.

In the following, non-limiting examples are given, which can be realized by a distributed intelligence of the furniture drives via a comparison of the at least one digital command with the at least one digital data set for selection for carrying out and/or via a data communication with additional furniture drives, particularly favorable by the method according to the invention, the computer program product, the assembly and/or the furniture drive:

For a piece of furniture in the form of a shelf or a base cabinet, at least one furniture drive of an interior pull-out is actuated by a voice command, wherein at least one additional furniture drive of a front pull-out is activated in parallel or in a sequentially synchronized manner in order to move the two moveable furniture parts by a digital command of the command transmitter. If a collision is impending, the movements are stopped, wherein if the synchronization is correct and there is no potential collision, the movements are carried out. The feasibility as well as a changed state of the operating positions of the moveable furniture parts are transmitted to the command transmitter in the form of a piece of digital information. The state parameters are changed after completion of the individual movements.

For a piece of furniture in the form of a furniture cupboard, the interior pull-out may only be opened by a furniture drive when a revolving door has reached a specific minimum aperture angle or a specific relative position to a furniture body. The minimum aperture angle can be stored as a static parameter in the form of a collision parameter of the storage unit, wherein a proper sequence of movements, in which a synchronized movement is effected by the furniture drives, can be ensured by means of data communication between the furniture drives. A synchronization can for instance be stored by a reference ride of the storage units carried out by the user. Synchronized furniture drives can control a motion sequence of the at least one moveable furniture part based on a time offset and/or based on a spatial position of the at least one moveable furniture part.

For a moveable furniture part in the form of a shared front of individual carcasses, the furniture drives arranged at the front must communicate with one another, wherein, in the event of a digital command to a furniture drive, the furniture drive communicates with the additional furniture drives in order to jointly move the front when a selection is made to carry out the digital command.

Particularly preferable are moveable furniture parts in the form of drawers, furniture doors, doors, flaps and/or liftable drawers.

If a digital command comprises a closing command for a moveable furniture part that is to cover, for instance, a microwave, an oven, or a coffee machine during operation, a selection for not executing the digital command is made, and digital information is transmitted to the command transmitter. For instance, the household appliance can also automatically transmit a locking command to the furniture drive as a command transmitter in order to inhibit an unwanted closing for safety reasons.

When transmitting the at least one digital command of the command transmitter, the at least one piece of digital information of the at least one furniture drive and/or of information between the at least one furniture drive and the at least one additional furniture, it can be provided that, in a dispatch method step, sending
is unidirectional to a receiving device of the data forwarding device and/or
is addressed directly to the receiving device of the data forwarding device and/or
is carried out without a confirmation of receipt, preferably without an unsolicited confirmation of receipt, by a transmitting device of the data forwarding device, and/or
is carried out without a check of the readiness for reception of the receiving device of the data forwarding device and/or
is carried out with a fixed predefined or predefinable routing and/or
is carried out according to a ShockBurst™ or Enhanced ShockBurst™ transmission protocol.

The characteristics of the method claims are applicable correspondingly to the assembly claims and/or the furniture drive claims, as well as vice versa.

Further details and advantages of the present invention are explained in more detail below based on the figure description with reference to the embodiments shown in the drawings. Therein it is shown:

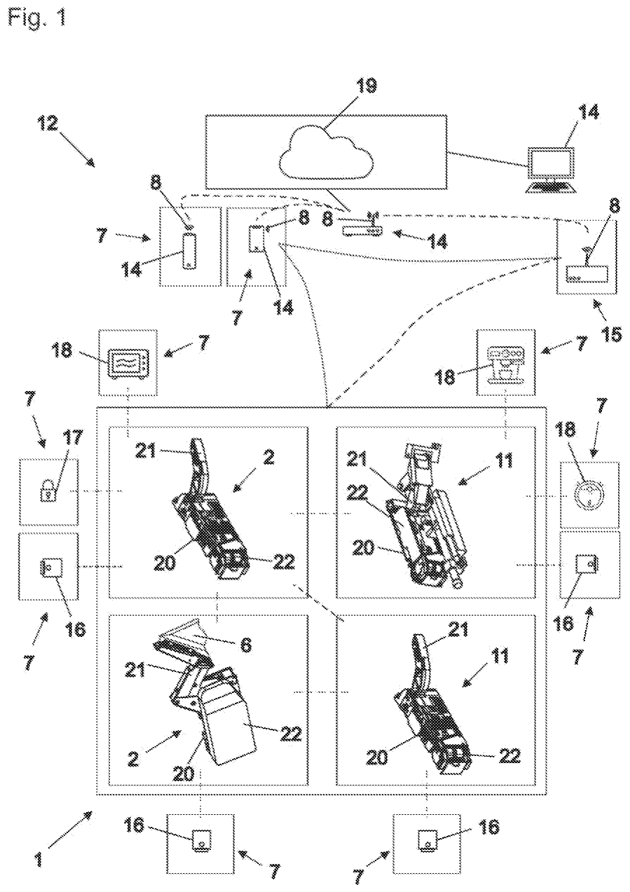

FIG. 1 an assembly of four furniture drives and a plurality of command transmitters which are connected in a network, in a schematic view providing an overview,

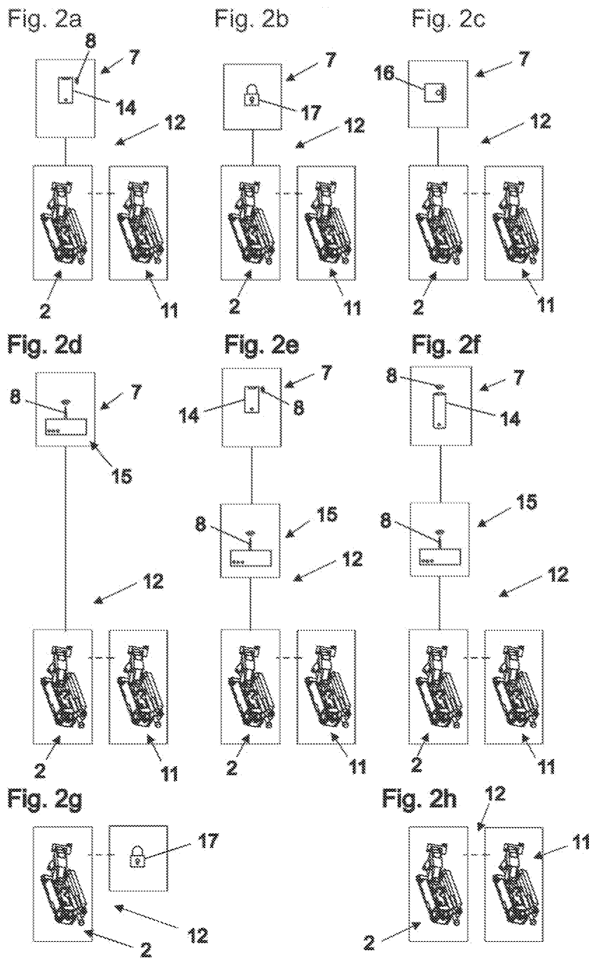

FIG. 2a-2f a data communication from a command transmitter to a furniture drive, wherein the furniture drive is in data connection with an additional furniture drive, in a schematic view,

FIG. 2g-2h a furniture drive in data connection with a furniture lock and an additional furniture drive in a schematic view,

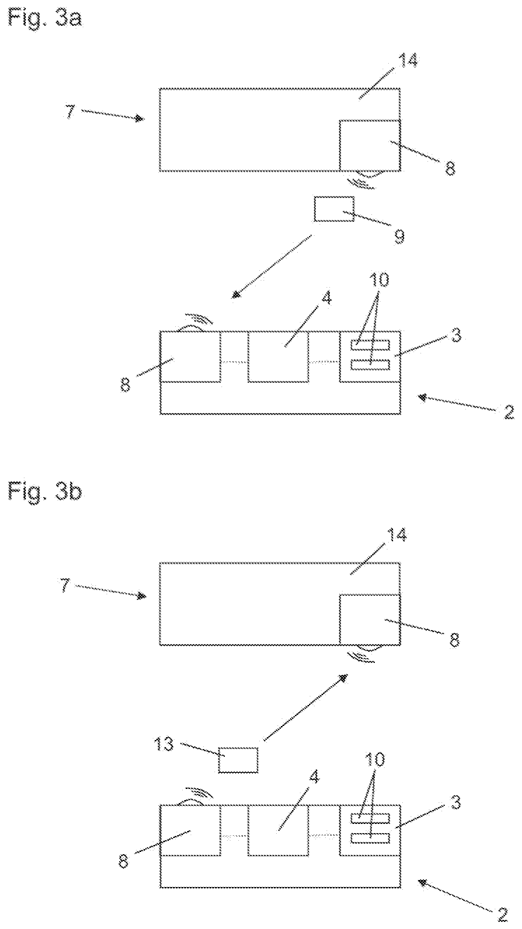

FIG. 3a a command transmitter and a furniture drive during transmission of a digital command from the command transmitter to the furniture drive in a schematic view,

FIG. 3b a command transmitter and a furniture drive during transmission of digital information of the furniture drive to the command transmitter in a schematic view,

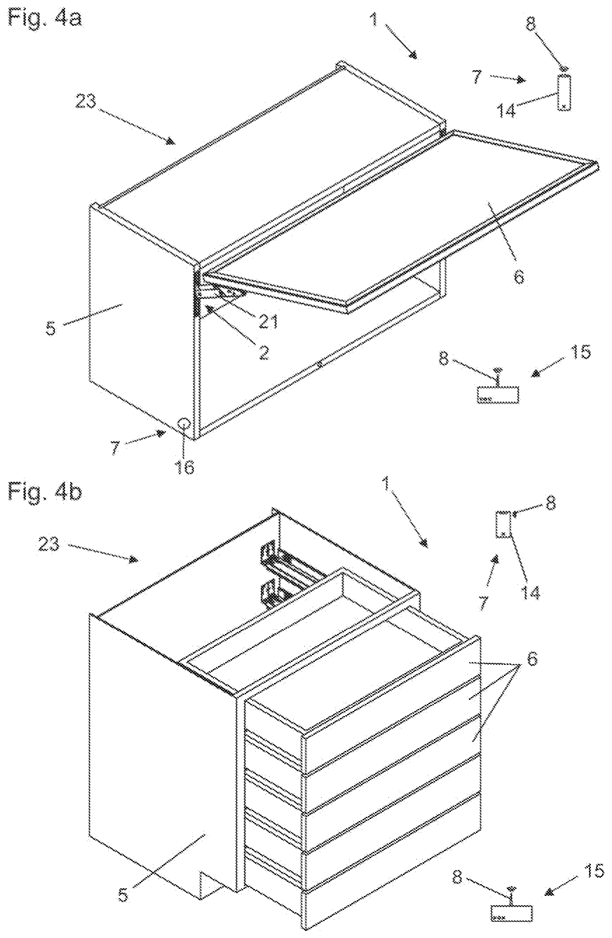

FIG. 4a an assembly consisting of a piece of furniture with a furniture body and a moveable furniture part in the form of a furniture flap as well as two command transmitters in a perspective view,

FIG. 4b a piece of furniture with a furniture body and five moveable furniture parts in the form of drawers as well as a command transmitter and a data transmission device in a perspective view.

FIG. 1 shows an assembly 1 of four furniture drives 2 and a movably mounted furniture part 6 arranged on the furniture drive 2 located at the bottom left, which is indicated in dotted lines. In general, a moveable furniture part 6 arranged on the respective furniture drive 2 is arranged on all furniture drives 2.

The assembly 1 comprises a plurality of command transmitters 7 spatially separate from the furniture drives 2, wherein the furniture drives 2 and the command transmitters 7 each comprise a data forwarding device 8.

The command transmitters 7 are present in the form of a furniture lock 17, household appliances 18 as a microwave, coffee machine and robot vacuum, radio switch elements 16, a data transmission device 15 as well as electronic devices 14 as a smartphone and voice recognition system. The radio switch elements 16 are each in wireless communication with a furniture drive 2. In general, the command transmitters could also be connected to the furniture drives 2 by cable.

The command transmitters 7 are designed in such a way as to wireless signal-transmitting digital commands 9 to data forwarding devices 8 of the furniture drives 2 via data forwarding devices 8 of the command transmitters 7. The computing units 4 of the furniture drives 2 are designed in such a way as to compare the digital commands 9 with digital data sets 10 stored in the storage units 3. The computing units 4 are designed in such a way as to make a selection for carrying out the digital commands 9 depending on a result of the comparison.

The furniture drives 2 of the assembly each comprise a fixing device 20 for fixing the furniture drive 2 to a furniture body 5, a positioning device 21, by means of which the moveable furniture part 6 is moveable relative to the furniture body 5, a drive unit 22, by means of which the positioning device 21 can be driven electrically, a storage unit 3, a computing unit 4, and a data forwarding device 8. A computer program product is stored in the furniture drives 2, which can be carried out by the computing unit 4, wherein the computer program product comprises commands which, when carried out by the computing units 4, cause them to carry out a method for operating the assembly out of the storage units 3, which are in a data connection with the computing units 4.

The command transmitters 7 communicate with the data forwarding devices 8 of the furniture drives 2 via ESB, wherein the smartphone can additionally communicate directly with the data forwarding devices 8 via ELB. The data forwarding devices 8 of the furniture drives 2 communicate with the additional furniture drives 11 via ESB.

The command transmitters 7 in the form of the voice recognition system and the smartphone transmit the digital commands 9 to the data forwarding devices 8 of the furniture drives 2 via a data transmission device 15 spatially separate from the command transmitter 7, wherein the data transmission device 15 communicates with the data forwarding devices 8 of the furniture drives 2 via ESB, and the command transmitters 7 communicate with the data transmission device 15 via WiFi. A router is interposed between the command transmitters 7 and the data transmission device 15, which can communicate via WAN and is in connection with a cloud 19.

An electronic device 14 that is in data communication with the cloud 19 can tap into a data communication and, for instance, evaluate log information for analysis purposes.

The voice recognition system and the smartphone determine information such as the digital data sets 10 of the furniture drives 2 and the additional furniture drives 11 through a connection with the data transmission device 15, as well as information of the network 12, in which the furniture drives 2 are imaged,

The network 12 comprises the entities of the command transmitters 7, the furniture drives 2 as well as the additional furniture drives 11, the cloud 19, the router and the data transmission device 15.

The furniture drives 2 can communicate with additional furniture drives 11, wherein the furniture drives 2 can compare digital data sets 10 and/or instruct the additional furniture drives 11 to a synchronized motion of the moveable furniture part 6 without collision of moveable furniture parts 6.

A furniture drive 2 can act as a command transmitter 7 for an additional furniture drive 11.

The command transmitter 7 determines information such as the digital data sets 10 of the furniture drives 2 and the additional furniture drives 11 as well as information of the network 12, in which the furniture drives 2 are imaged, by a connection with exactly one data forwarding device 8 of a furniture drive 2 or the data transmission device 15.

FIG. 2a shows an electronic device 14 in the form of a smartphone with a data forwarding device 8, which is in direct wireless signal-transmitting data connection with a data forwarding device 8 of a furniture drive 2. The furniture drive 2 is in turn in direct wireless signal-transmitting data connection with an additional furniture drive 11.

If the command transmitter 7 transmits a digital command 9 in a wireless signal-transmitting manner via the data forwarding device 8 of the command transmitter 7 to the data forwarding device 8 of the furniture drive 2, the computing unit 4 of the furniture drive 2 compares the digital command 9 with a digital data set 10 stored in the storage unit 3, and the computing unit 4 makes a selection for carrying out the digital command 9 depending on a result of the comparison.

The digital command 9 can comprise in the form of a closing command or an opening command, in which the furniture part 6 is arranged by the furniture drive 2 from an operating position relative to the furniture body 5 to an operating position different therefrom, and/or a locking command or an unlocking command, in which the furniture part 6 remains in an operating position. The furniture drives 2 can also send digital commands 9 to the additional furniture drives 11.

The selection is transferred to a Boolean variable, wherein the Boolean variable has a value of 0 in case of feasibility of the digital command 9, and a value of 1 in case of non-feasibility of the digital command 9.

In case of a selection for the feasibility of the digital command 9, the data forwarding device 8 of the furniture drive 2 communicates via ESB with the data forwarding device 8 of the additional furniture drive 11, wherein the furniture drive 2 and the additional furniture drive 11 jointly arrange a moveable furniture part 6 in parallel from an operating position into an additional operating position, which is separate from the operating position, and relative to the furniture body 5 and/or lock the furniture part 6 in an operating position. A locking can be released by an additional digital command 9, which comprises an unlocking command. In general, two moveable furniture parts 6 can also be moved jointly in parallel or jointly sequentially by the furniture drive 2 and the additional furniture drive 11, in particular taking into account a possible collision and/or necessary synchronization.

FIG. 2b differs from FIG. 2a in so far as the command transmitter 7 is present in the form of a furniture lock 17. The data forwarding device 8 of the furniture drive 2 and the command transmitter 7 communicate bidirectionally sequentially. In general, however, a bidirectional parallel data communication is also possible.

FIG. 2c differs from FIG. 2a in so far as the command transmitter 7 is present in the form of a radio switch element 16. A data communication between the data forwarding device 8 of the command transmitter 7 and the data forwarding device 8 of the furniture drive 2 is encrypted and takes place during defined time windows.

FIG. 2d differs from FIG. 2a in so far as the command transmitter 7 is present in the form of a data transmission device 15. The command transmitter 7 comprises a computing unit 4 and a storage unit 3, wherein a current state, log information and operating information of the furniture drive 2 and the additional furniture drive 11 are read out from the storage unit 3. Log information and operating information of the data transmission device 15 can be read out by an electronic device 14.

The furniture drive 2 transmits, in a wireless signal-transmitting manner, digital information 13 to the data forwarding device 8 of the command transmitter 7 via the data forwarding device 8 of the furniture drive 2 depending on the selection of comparing the digital command 9 with the digital data set 10, wherein
in case of feasibility of the digital command 9, the digital information 13 includes a confirmation of feasibility, and
in case of non-feasibility of the digital command 9, the digital information 13 includes a confirmation of non-feasibility, wherein the digital information 13 includes a justification of non-feasibility with a diagnosis related to the selection.

FIG. 2e differs from FIG. 2a in so far as the command transmitter 7 in the form of the smartphone does not communicate directly with the furniture drive 2, but a data transmission device 15 is interposed. The command transmitter 7 and the data transmission device 15 can make a preselection for carrying out the digital command 9 based on information of the network 12 in which the at least one furniture drive 2 is located, wherein carrying out the digital command 9 by the furniture drive 2 can be rejected via the intelligence intrinsic to the furniture drive 2 in terms of selection by the computing unit 4.

Before the digital command 9 is received by the furniture drive 2, it can be provided that a tactile command given by a user is translated into the digital command 9 via the electronic device 14. The translation can be carried out by the command transmitter 7, the data transmission device 15 or the cloud 19.

The data forwarding device 8 of the furniture drive 2 transmits digital information 13 to the data forwarding device 8 of the command transmitter 7 in the event of a change of state of the furniture drive 2, for instance after a motion of the moveable furniture part 6 into a changed operating position. A status message such as “cupboard has been opened” can be displayed to an electronic device 14 in relation to the change of state.

FIG. 2f differs from FIG. 2e in so far as the command transmitter 7 is present as a voice recognition system.

Before the digital command 9 is received by the furniture drive 2, it can be provided that a verbal voice command, or a tactile command, given by a user is translated into the digital command 9 via the electronic device 14. A user identification of the voice command can moreover prevent unauthorized persons from verbally operating a furniture drive 2. The translation can be performed by the command transmitter 7, the data transmission device 15, or the cloud 19.

The furniture drive 2, the command transmitter 7, and the data transmission device 15 are added to a network 12, wherein the network 12 has been transmitted to the command transmitter 7 in order to be able to control all entities located in the network 12 as well as to determine information such as log information.

FIG. 2g shows a furniture drive 2 in connection with a furniture lock 17. The furniture lock 17 can act as a command transmitter 7 by transmitting a digital command 9, such as a locking command, to the furniture drive 2. On the other hand, the furniture drive 2 can also act as a command transmitter 7 by transmitting a locking command to the furniture lock 17 by a digital command 9 from a command transmitter 7. The data communication can in general be bidirectional or unidirectional. In general, the furniture lock 17 can also be formed by an additional furniture drive 11, which is locked by a locking command and can again move a moveable furniture part 6 by an unlocking command in the form of a digital command 9, Correspondingly, a robot vacuum or another household appliance 18 can also be placed instead of the furniture lock 17.

FIG. 2h shows a furniture drive 2 in connection with an additional furniture drive 11. If a digital command 9 is transmitted to the furniture drive 2, the furniture drive 2 can instruct the additional furniture drive 11, in particular by means of a digital command 9, in such a way as to generate a motion independently and without any relation to the furniture drive 2 or to generate a synchronized motion with the furniture drive 2.

The digital data set 10 of the furniture drive 2 has collision parameters stored with regard to the additional furniture drive 11, and the digital data set 10 of the additional furniture drive 11 has collision parameters stored with regard to the furniture drive 2. In general, it can be sufficient that merely collision parameters are stored in the digital data set 10 of a furniture drive 2. An analogous approach applies to additional static parameters such as synchronization parameters.

The data communication between the furniture drive 2 and the additional furniture drive 11 can be designed bidirectionally, wherein unidirectional data communication is also possible, wherein particularly preferably, the additional furniture drive 11 also makes a selection on the basis of a comparison with the digital data set 10 present to it.

FIG. 3a shows a command transmitter 7 with a data forwarding device 8 during a transmission of a digital command 9 to a data forwarding device 8 of a furniture drive 2. The furniture drive 2 comprises a storage unit 3 and a computing unit 4, wherein the data forwarding device 8, the storage unit and the computing unit 4 are in signal-conducting data connection, wherein these can in general also be designed integrated on a chip.

A digital data set 10 is previously stored in the storage unit 3 of the furniture drive 2 via the data forwarding device 8 of an electronic device 14, wherein the computing unit 4 can compare the digital command 9 with the digital data set 10 with regard to feasibility and make a decision whether the digital command 9 would for instance cause a collision of moveable furniture parts 6 or whether an additional furniture drive 11 should carry out a synchronized movement, wherein a digital command 9 is transmitted to the additional furniture drive 11 via the data forwarding device 8 of the furniture drive 2.

Static parameters in the form of reference parameters, synchronization parameters, coupling parameters, state parameters and collision parameters relating to additional furniture drives 11 and a network 12 are stored in the two digital data sets 10 present in the storage unit 3, wherein the furniture drive 2 is imaged in this network 12. When the state of the furniture drive 2 changes, the state parameter is automatically changed depending on the corresponding operating position.

The moveable furniture part 6 arranged on the furniture drive 2 is not shown in order to provide an overview, wherein the furniture drive 2 moves the moveable furniture part 2 via a positioning device 21 that is also not visible in the illustration,

FIG. 3b differs from FIG. 3a in so far as the computing unit has already made a selection regarding the feasibility of the digital command 9, and transmits a piece of digital information 13 regarding the feasibility back to the command transmitter 7. The piece of digital information 13 can for instance already contain a change of state, a message for which reason the digital command 9 could not be carried out, or information about a synchronized movement with an additional furniture drive 11. Furthermore, the piece of digital information 13 can contain information to additional furniture drives 11 such as digital data sets 10 of the additional furniture drives 11 and/or information of the network 12.

The furniture drive 2 has already been coupled with an additional furniture drive 11 (not visible in the illustration) and synchronized via a reference ride carried out by a user. Furthermore, the furniture drive 2 has been initialized via a reference ride carried out by a user as well as coupled to the command transmitter 7. In general, the command transmitter 7 can also be initialized via a reference ride to be carried out by a user.

Via the electronic device 14, two digital data sets 10 have been stored in the storage unit 3 depending on a reference ride carried out by a user, wherein additional digital data sets 10 can be added to the storage unit 3 at any time.

If a digital command 9 is not feasible, an error message with a help dialog is attached to the command transmitter 7 in the digital information 13, wherein for instance a conflict with an additional furniture drive 11, a command transmitter 7 or a problematic network structure can be comprised.

FIG. 4a shows a piece of furniture 23 with a furniture part 6 movably mounted on a furniture body 5 in the form of a furniture flap, wherein the furniture part 6 can be arranged in at least two operating positions relative to the furniture body 5 by means of two synchronized furniture drives 2 arranged on the furniture part 6. The furniture drives 2 can be controlled via a command transmitter 7 in the form of a voice recognition system, wherein a voice command sent by the data forwarding device 8 is translated into a digital command 9, for instance in a cloud, and is forwarded to the furniture drive 2 via a data transmission device 15.

The command transmitter 7 communicates with the data transmission device 15 via WiFi, wherein the data transmission device 15 communicates with the furniture drive 2 via ESB in order to minimize latency.

The moveable furniture part 6 is jointly moved in parallel between two operating positions relative to the furniture body 5 by the furniture drives 2 (in the illustration, the second furniture drive 2 is covered by the moveable furniture part 6). The number of operating positions is generally arbitrary. In general, the furniture part 6 can also be present in the form of two furniture parts 6, which can then be individually controlled by the two furniture drives 2, in particular sequentially.

An additional command transmitter 7 in the form of a radio switch element 16 is arranged on the furniture body 5 in order to activate the furniture drives 2 by a direct digital command 9 via actuation of the radio switch element 16, and to instruct them to move the moveable furniture part 6, in particular via ESB. The position of the radio switch element 16 is generally arbitrary, wherein the latter can also be arranged spatially separate from the piece of furniture 23.

The furniture drives 2 are arranged spatially separate from the command transmitters 7 of the assembly 1 on the piece of furniture 23, wherein the command transmitters 7 and the furniture drives 2 each comprise a data forwarding device 8.

FIG. 4b shows a piece of furniture 23 with five furniture parts 6 in the form of drawers movably mounted on a furniture body 5, which are individually movable by furniture drives 2. In this embodiment, a digital data set 10 is stored in the furniture drives 2 directly via ELB.

Via a subsequent tactile command at the electronic device 14, the latter is digitally translated in a wireless signal-transmitting manner via WiFi to a data transmission device 15, and forwarded, translated in the form of a digital command 9, to a furniture drive 2 via ESB. Generally, the translation into the digital command 9 can already be carried out in the electronic device 14 as the command transmitter 7.

The five moveable furniture parts 6 can be moved in parallel or sequentially by the furniture drives 2 (covered in the illustration by the furniture parts 6) between at least two operating positions relative to the furniture body 5.

### LIST OF REFERENCE SIGNS

assembly (1)
furniture drive (2)
storage unit (3)
computing unit (4)
furniture body (5)
furniture part (6)
command transmitter (7)
data forwarding device (8)
digital command (9)
digital data set (10)
additional furniture drive (11)
network (12)
digital information (13)
electronic device (14)
data transmission device (15)
radio switch element (16)
furniture lock (17)
household appliance (18)
cloud (19)
fixing device (20)
positioning device (21)
drive unit (22)
piece of furniture (23)

1. A method for operating an assembly of:
at least one furniture drive with at least one storage unit and at least one computing unit,
at least one furniture part moveably mounted on a furniture body, wherein the at least one furniture part can be arranged in at least two operating positions relative to the furniture body by the at least one furniture drive,
and at least one command transmitter spatially separate from the at least one furniture drive,
wherein the at least one furniture drive and the at least one command transmitter each comprise at least one data forwarding device,
the method comprising the following method steps, which are particularly to be carried out in chronological order:
the at least one command transmitter transmits, in particular wireless signal-transmitting, at least one digital command to the at least one data forwarding device of the at least one command transmitter of the at least one furniture drive,
the at least one computing unit of the at least one furniture drive compares the at least one digital command with at least one digital data set which is stored or can be stored in the at least one storage unit, and
the at least one computing unit makes a selection for carrying out the at least one digital command on the basis of a result of the comparison.

2. The method according to claim 1, wherein the at least one digital command is in the form of a closing command or an opening command, in which the at least one furniture part can be arranged by the at least one furniture drive from an operating position relative to the furniture body into an operating position different therefrom, and/or a locking command or an unlocking command, in which the at least one furniture part remains in an operating position.

3. The method according to claim 1, wherein the selection is transferred into a Boolean variable, wherein the Boolean variable has the value 0 or 1 in case of feasibility of the at least one digital command, and the value 1 or 0 in case of non-feasibility of the at least one digital command.

4. The method according to claim 1, wherein, in case of a selection for the feasibility of the at least one digital command, the at least one data forwarding device of the at least one furniture drive communicates, preferably via ESB, with at least one data forwarding device of at least one additional furniture drive, wherein it is preferred provided that the at least one furniture drive the at least one additional furniture drive jointly assemble the at least one furniture part, preferably in parallel or sequentially, from an operating position into an additional operating position separate from the operating position relative to the furniture body, and/or lock the at least one furniture part in an operating position.

5. The method according to claim 1, wherein the at least one digital data set comprises static parameters, preferably in the form of a reference parameter, synchronization parameter, coupling parameter, state parameter and/or collision parameter, to at least one possibly present additional furniture drive, particularly preferably of a network, in which the at least one furniture drive is located, wherein it is preferably provided that the state parameter is changeable depending on at least one operating position.

6. The method according to claim 1, wherein in a subsequent method step the at least one furniture drive, in particular wireless signal-transmitting, provides via the at least one data forwarding device of the at least one furniture drive at least one piece of digital information depending on the selection to the at least one data forwarding device of the at least one command transmitter, wherein it is preferably provided that:
in case of feasibility of the at least one digital command, the at least one piece of digital information contains a confirmation of feasibility,
in case of non-feasibility of the at least one digital command, the at least one piece of digital information contains a confirmation of non-feasibility, wherein the at least one piece of digital information preferably contains a reason for non-feasibility, particularly preferable in the form of a diagnosis with respect to the selection.

7. The method according to claim 1, wherein the at least one data forwarding device of the at least one furniture drive and the at least one command transmitter communicate bidirectionally in parallel or bidirectionally sequentially.

8. The method according to claim 1, wherein the at least one data forwarding device of the at least one furniture drive transmits at least one piece of digital information to the at least one data forwarding device of the at least one command transmitter in the event of a change of state of the at least one furniture drive, wherein a status message concerning the change of state is preferably displayed at an electronic device (14), particularly preferable in the form of a mobile terminal, smartphone or computer.

9. The method according to claim 1, wherein the at least one command transmitter communicates with the at least one data forwarding device of the at least one furniture drive via BLE and/or ESB, and/or the at least one data forwarding device of the at least one furniture drive communicates with at least one possibly present additional furniture drive via ESB.

10. The method according to claim 1, wherein the at least one digital command is transmitted to the at least one data forwarding device of the at least one furniture drive via at least one data transmission device spatially separate from the at least one command transmitter, wherein it is preferably provided that the at least one data transmission device communicates with the at least one data forwarding device of the at least one furniture drive via ESB.

11. The method according to claim 1, wherein the at least one command transmitter determines information, preferably at least one digital data set, of at least one additional furniture drive and/or of a network in which the at least one furniture drive is imaged, by a connection to the at least one data transmission device.

12. The method according to claim 1, wherein the at least one command transmitter determines information, preferably at least one digital data set, of at least one additional furniture drive and/or of a network in which the at least one furniture drive is imaged, by a connection with at least one, preferably exactly one, data forwarding device of the at least one furniture drive and/or at least one, preferably exactly one, possibly present data transmission device.

13. The method according to claim 1, wherein in a preceding method step, preferably via at least one electronic device, preferably in the form of a mobile terminal, smartphone or computer,
at least two furniture drives are coupled to one another and/or synchronized via a reference ride to be carried out by a user,
the at least one furniture drive is initialized via a reference ride to be carried out by a user,
the at least one furniture drive is coupled to the at least one command transmitter and/or the at least one command transmitter is initialized via a reference ride to be carried out by a user,
at least one digital data set is stored in the at least one storage unit depending on a reference ride to be carried out by a user, and/or
the at least one furniture drive, the at least one command transmitter and/or at least one possibly present data transmission device are added to a network, wherein it is preferably provided that the network is transmitted to the at least one command transmitter, and/or
optionally at least one digital information is transmitted to the at least one command transmitter regarding an error message, particularly preferable with a help dialog, regarding at least one furniture drive and/or a possibly present data transmission device.

14. The method according to claim 1, wherein the at least one command transmitter comprises at least one computing unit and at least one storage unit, wherein it is preferably provided that at least one status parameter, at least one piece of log information and/or at least one piece of operating information of the at least one furniture drive and/or of a possibly present data transmission device is read out from the at least one storage unit.

15. The method according to claim 1, wherein the at least one command transmitter is designed in the form of a radio switch element, a data transmission device, a furniture lock, a household appliance, an additional furniture drive and/or an electronic device, preferably in the form of a mobile terminal, smartphone or computer.

16. The method according to claim 1, wherein the at least one command transmitter and/or the at least one possibly present data transmission device makes a preselection for carrying out the at least one digital command, preferably based on information of the network in which the at least one furniture drive is located.

17. The method according to claim 1, wherein a data communication between the at least one data forwarding device of the at least one command transmitter and the at least one data forwarding device of the at least one furniture drive is enabled in encrypted form and/or during defined time windows.

18. The method according to claim 1, wherein in a preceding method step at least one verbal voice command given by a user, preferably with user identification, and/or at least one tactile command is translated into the at least one digital command via at least one electronic device, particularly preferable in the form of a mobile terminal, smartphone or computer.

19. The method according to claim 18, wherein the at least one tactile command and/or the at least one verbal voice command is translated into the at least one digital command by the at least one command transmitter and/or in at least one cloud.

20. A computer program product comprising commands which, when carried out by a computing unit, cause the latter to carry out the method according to claim 1 out of a storage unit which is or can be brought into a data connection with the computing unit.

21. An assembly comprising at least one furniture drive with at least one storage unit and at least one computing unit, at least one furniture part moveably mounted on a furniture body, wherein the at least one furniture part can be arranged by the at least one furniture drive in at least two operating positions relative to the furniture body, and at least one command transmitter spatially separate from the at least one furniture drive, wherein the at least one furniture drive and the at least one command transmitter each comprise at least one data forwarding device, wherein the at least one command transmitter is designed to transmit at least one digital command to the at least one data forwarding device of the at least one furniture drive via the at least one data forwarding device of the at least one command transmitter, in particular by wireless signal transmission, the at least one computing unit of the at least one furniture drive is designed to compare the at least one digital command with at least one digital data set stored in the at least one storage unit, and the at least one computing unit is designed to make a selection for carrying out the at least one digital command on the basis of a result of the comparison.

22. The assembly according to claim 21, wherein at least two furniture drives are arranged on the at least one moveable furniture part, wherein the at least one moveable furniture part is jointly moveable in parallel between the at least two operating positions relative to the furniture body by the at least two furniture drives.

23. The assembly according to claim 21, wherein in each case at least one furniture drive is arranged on at least two moveable furniture parts, wherein the at least two moveable furniture parts are moveable in parallel or sequentially by the at least two furniture drives between the at least two operating positions relative to the furniture body.

24. A furniture drive comprising:
at least one fixing device for fixing the furniture drive to a furniture body,
at least one positioning device with which at least one moveable furniture part is moveable relative to the furniture body,
at least one drive unit, with which the at least one positioning device can be driven, in particular electrically,
at least one storage unit,
at least one computing unit, and
at least one data forwarding device
wherein the furniture drive has stored on it the computer program product according to claim 20 to be carried out by the at least one computing unit.

25. The furniture drive according to claim 24, wherein at least one digital data set can be stored in the at least one storage unit, preferably via the at least one data forwarding device by at least one electronic device, wherein the at least one digital data set preferably comprises static parameters in the form of a reference parameter, synchronization parameter, coupling parameter, state parameter and/or collision parameter to at least one additional furniture drive.
